(19) United States
(12) Patent Application Publication
(10) Pub. No.: US 2009/0248441 A1
(43) Pub. Date: Oct. 1, 2009

(54) MEDICAL REPORT SYSTEM, MEDICAL REPORT VIEWER, MEDICAL REPORT PROGRAM, AND METHOD OF EDITING AND DISPLAYING MEDICAL REPORT

(75) Inventor: Takashi OKADA, Ashigarakami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 12/413,187

(22) Filed: Mar. 27, 2009

(30) Foreign Application Priority Data
Mar. 27, 2008 (JP) 2008-084969

(51) Int. Cl. G06Q 50/00; G06F 3/048

(52) U.S. Cl. 705/2; 715/780; 715/764

(57) ABSTRACT

A report editor screen of a medical report system is provided with a plurality of entry areas for entering a plurality of findings. Every entry area is provided with check boxes for inputting a command to link the entered finding with an inspection purpose. When the inspection purpose is selected by checking one of the check boxes in one entry area, the finding entered in this entry area is linked with the selected inspection purpose. Data of the medical report is recorded in such a manner that each finding may be handled individually as a unit. On a report display screen of the medical report system, the medical report is displayed in such a manner that shows linkage between the findings and respective inspection purposes.

### FIELD OF THE INVENTION

The present invention relates to a medical report system that assists doctors in producing medical reports and viewing them. The present invention relates also to a medical report viewer, a program for editing medical reports, and a method of editing and displaying the medical report.

### BACKGROUND OF THE INVENTION

Medical report systems have been known, which assist us in producing medical reports that report results of radiological interpretation of inspection images as obtained by modalities, i.e. machines for medical inspections such as CR (Computed Radiography), CT (Computed Tomography), MRI (Magnetic Resonation Imaging) or the like. The medical report system also manages the produced medical reports so as to be available for many clinical purposes. For example, the medical report, hereinafter called simply as the report, is produced by a radiological doctor who is specialized in interpreting the inspection images.

The report system is constituted of a report producing terminal and a database server storing data of inspection results, including the reports produced on the report producing terminal and the inspection images obtained by the modalities. The report producing terminal has an editorial function of receiving entries of findings and compiling data of the entered findings into a report. The finding may include an observation record about the condition of a lesion perceived in the inspection image by the image interpreter, e.g. a radiological doctor, and a result of diagnosis on the lesion, such as the name of disease, based on the inspection image. The inspection image is observed or viewed by the interpreter on a terminal with an image display function for displaying the inspection images, which may be the report producing terminal or a specific image display terminal.

The database server stores the data of the reports and the inspection images in such a condition that the data is readable through a network. A doctor who requests a radiological image interpretation, hereinafter referred to as the requesting doctor, makes an access to the database server through a terminal installed in a diagnosis-and-treatment department, to read out and view the result of interpretation, including the report and the inspection images.

According to a prior art report system disclosed in JPA 2005-025669, an entry box is inserted in an image display screen for displaying the inspection images, so that the finding may be written in the entry box on the image display screen. In order to input the finding on a report editor screen while observing the inspection images, the radiological doctor has to look at the image display screen and the report editor screen in parallel and alternately. Allowing inputting the finding on the inspection image reduces the eyestrain of the radiological doctor caused by switching the view point between the image display screen and the report editor screen.

In this prior art report system, more than one entry box can be put on the inspection images. Text data of the findings written in the entry boxes are respectively linked with data of the corresponding inspection images, and then put together into a report. Data of the report is stored with the inspection image data in a database. In the process for linking the respective findings with the inspection images, an identification code (ID) of one corresponding image to one finding is stored as linkage information in combination with position data of the entry box of the one finding on the image display screen. Therefore, it is possible to view the report on the image display screen as the finding is inserted in the same position as its entry position on the corresponding inspection image on the basis of the linkage information.

It is also possible to display various findings in an array on a report display screen aside from the image display screen. The report display screen is provided with respective display columns for the various findings. Each display column is attended by an individual ID that identifies the doctor who has written the finding as displayed in this display column.

The report display screen and the image display screen cooperate with each other such that the image display screen displays inspection images corresponding to a selected finding that is selected from among the various findings displayed on the report display screen, by clicking a mouse on this finding. Since several tens or hundreds of tomograms are acquired as the inspection images through a CT or MRI inspection, among which focused inspection images can vary from one radiological doctor to another, the linkage between the individual findings and their corresponding inspection images makes it easy for the viewer of the report to retrieve and contrast the findings with the corresponding inspection images.

The art of compiling various findings into a report is very practical, because it contributes to producing a superior report that facilitates comparing and contrasting various findings written by different doctors, in comparison with those reports which contain only one finding individually. There has been an increasing trend toward a multiple interpretation in medical practice, whereby different doctors interpret the inspection images taken from the same patient for the sake of improvement in accuracy of the diagnosis or for the sake of education of trainee doctors. In view of this, the art of compiling the findings is also useful.

Moreover, the art of compiling various findings is useful not only for the cooperative production of a report by many doctors but also for a case where a doctor produces a report individually. For example, if many lesions are found in the inspection images taken through the same inspection, the doctor writes findings for the respective lesions in a report, and links the findings with the corresponding inspection images.

Despite the above described advantages, however, the compilation of various findings involves a new problem because of the increased number of findings. That is, it becomes harder for the requesting doctor to find out suitable findings for the purpose of the inspection or the intension of the requesting doctor.

For example, the requesting doctor orders an inspection with its purpose, which may be scrutinizing for examining the cause of a disease of which a patient mainly complains. The purpose of the inspection may also be differential diagnosis for judging whether a tumor is a benign one or a malignant one, follow-up for checking the progress of a disease, metastatic survey for searching for metastases, or judgment on the effect of treatment.

If an inspection request is offered with more than one purpose, findings are written in a report to answer the respective purposes in an inspection department that receives the inspection request. As the number of inspection purposes increases, the number of findings in the report increases correspondingly, so the correspondence between the findings and the inspection purposes is likely to become unobvious. Unclear correspondence between the findings and the inspection purposes makes the report inconvenient for the viewer of the report. For example, it takes long time for the requesting doctor to find a desired finding in the report. If the report contains findings of different radiological doctors, the number of findings increases with the number of doctors, so the lucidity of the report lowers more remarkably.

The report system disclosed in the above-mentioned prior art merely links each individual finding with its corresponding inspection image, and considers nothing about the above-described problem or solution for the problem.

### SUMMARY OF THE INVENTION

In view of the foregoing, a primary object of the present invention is to provide a medical report that allows the viewer to grasp the correspondence between findings and respective inspection purposes even if the medical report contains many findings.

A medical report system of the present invention comprises an editorial processing device for editing a medical report that contains a plurality of findings, among which at least one finding is entered in accordance with a designated purpose, in such a manner that data of each finding may be handled individually as a unit; and a linking device for linking the at least one finding with the designated purpose.

Preferably, the medical report system of the invention further comprises an order taking device for taking an order that records contents of a request for producing the medical report, wherein at least a purpose is designated in the order and is read out from the order.

Preferably, the medical report system further comprises a first console control device for controlling a report editor screen as a graphical user interface, wherein the report editor screen is provided with a plurality of entry areas for entering a plurality of findings to be contained in the medical report. The report editor screen is preferably provided with a first operation tool for designating a purpose to be linked with the finding entered in each of the entry areas, and the linking device links the finding with the purpose as designated by the first operation tool.

Preferably, the medical report system further comprises a second console control device for controlling a report display screen to display the medical report in such a manner that shows linkage between the findings and designated purposes.

The report display screen is preferably provided with a second operation tool, through which at least a purpose is designated to input a command to change display style of the findings corresponding to the designated purpose. Then, a process of changing the display style of the findings on the report display screen is executed in accordance with the command input through the second operation tool.

As the display style, there may preferably be at least one of a refined display style and a sorted display style. The refined display style is for displaying those findings on the report display screen which are retrieved using the designated purpose as a search key, whereas the sorted display style is for displaying the findings in groups sorted according to the designated purposes.

It is possible to include a variety of medical reports in the subject of the process of changing the display style, such as medical reports relating to different medical inspections or ones relating to past inspections.

Preferably, the second console control device controls an image display screen for displaying images relating to the medical report in cooperation with the report display screen, so as to switch the images or annotations inserted in the images on the image display screen in synchronism with the change in display style on the report display screen.

According to an embodiment, the medical report system of the present invention is comprised of a report producing apparatus provided with a first console control device for controlling a report editor screen as a graphical user interface, a report viewer apparatus provided with the second console control device, and a data storage in which a report database is built up for storing the medical reports, the data storage being connected to the report producing apparatus and the report viewer apparatus via a network so as to be able to communicate with each other.

A medical report viewer apparatus of the present invention comprises a console control device for outputting a report display screen to a display device, the report display screen displaying a medical report containing a plurality of findings, among which at least one finding is entered in accordance with a designated purpose and is linked with the designated purpose, in such a manner that data of each finding may be handled individually as a unit, wherein the console control device controls the report display screen in response to an operation command entered through the report display screen by operating an input device; and a device for executing a process of changing display style of the findings on the report display screen in accordance with a purpose or purposes designated through an operation tool provided on the report display screen.

A medical report program of the present invention programs a computer to perform a function of editing the medical report to contain a plurality of findings, among which at least one finding is entered in accordance with a designated purpose, in such a manner that data of each finding may be handled individually as a unit; and a function of linking the findings with respective purposes.

According to the present invention, a method of editing and displaying a medical report comprises steps of:

editing the medical report to contain a plurality of findings, among which at least one finding is entered in accordance with a designated purpose, in such a manner that data of each finding may be handled individually as a unit;

linking the findings with respective purposes; and

outputting a report display screen that displays the findings as contained in the medical report in such a manner that the findings are distinguishable from each other.

In a medical report edited according to the present invention, findings written for different purposes are linked with the respective purposes in such a manner that data of each finding may be handled individually. Therefore, it is possible to sort and display the findings according to their linkages with the purposes. So the report provided by the present invention ensures grasping the correspondence between findings and respective inspection purposes even if the medical report contains many findings.

### BRIEF DESCRIPTION OF THE DRAWINGS

The above and other objects and advantages of the present invention will be more apparent from the following detailed description of the preferred embodiments when read in connection with the accompanied drawings, wherein like reference numerals designate like or corresponding parts throughout the several views, and wherein:

FIG. 1 is a schematic diagram illustrating a structure of a medical information system;

FIG. 2 is an explanatory diagram illustrating an example of contents of an order;

FIG. 3 is a block diagram illustrating a fundamental structure of a computer, based on which a database server or a terminal is configured;

FIG. 4 is a schematic block diagram illustrating a report system;

FIG. 5 is an explanatory diagram illustrating a data structure of a report;

FIG. 6 is an explanatory diagram illustrating a report editor screen;

FIG. 7 is an explanatory diagram illustrating a report display screen;

FIG. 8 is an explanatory diagram illustrating cooperation of an image display screen with the report display screen;

FIG. 9 is a flowchart illustrating a sequence of procedures from issuing an order through producing a report to viewing the report;

FIG. 10 is an explanatory diagram illustrating a report display screen according to another embodiment, wherein past reports or reports of other type inspections may be included in the subject of refined display; and

FIG. 11 is an explanatory diagram illustrating an embodiment wherein an entry of a finding is made on an image display screen.

### DESCRIPTION OF THE PREFERRED EMBODIMENTS DESCRIPTION OF THE PREFERRED EMBODIMENTS

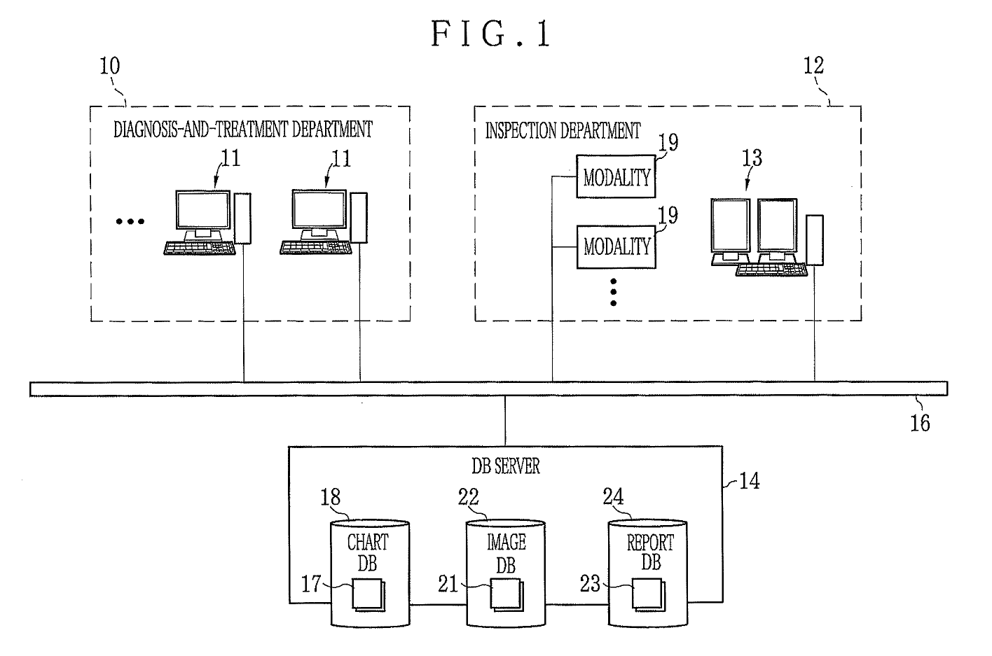

A medical information system shown in FIG. 1 is constructed in such a medical facility as hospital. The medical information system consists of diagnosis-and-treatment department terminals 11 arranged in diagnosis-and-treatment departments 10, a report producing terminal 13 arranged in a radiological inspection department, hereinafter called simply as the inspection department 12, and a database (DB) server 14, which are all connected to a network 16 to communicate with each other. The network 16 is, for example, a LAN (Local Area Network) laid in the hospital.

In the DB server 14, a plurality of databases are built up, including a chart DB 18 storing data of every patient's medical record 17, an image DB 22 storing data of inspection images 21 taken by such modalities 19 as CR devices, CT scanners and MRI machines, and a report DB 24 storing the data of reports 23 generated by the report producing terminal 13.

The DB server 14 functions as a PACS (Picture Archiving and Communication Systems) server. The DB server 14 receives via the network 16 the data of the inspection images 21 taken by the modalities 19 and stores the data in the image DB 22. The DB server 14 and the modalities 19 constitute the Picture Archiving and Communication System. The inspection image 21 is given an image ID to identify the individual inspection image 21. The data of each inspection image 21 is stored as a file that complies, for example, in the DICOM (Digital Imaging and Communication in Medicine) format, and a DICOM tag is attached to each file. The DICOM tag records accessory information including a patient ID, an inspection ID, an inspection date and an inspection type. So the data files of the inspection images 21 are retrievable from the image DB 22 by designating an item in the DICOM tag as a search key.

Moreover, the DB server 14 serves both as a medical chart system in cooperation with the diagnosis-and-treatment department terminals 11 and the chart DB 18, and as a report system in cooperation with the report producing terminal 13, the image DB 22 and the report DB 24. The data of the reports 23 is stored in the report DB 24 in a retrievable way with such a search key as the inspection ID, the patient ID and a patient's name.

According to this embodiment, the respective databases 18, 22 and 24 are built up in the same DB server 14. It is, however, possible built up the databases 18, 22 and 24 separately in different database servers.

The diagnosis-and-treatment department terminal 11 is operated by a requesting doctor to issue an order of requesting an inspection to the inspection department 12 as well as to review or input a chart. The diagnosis-and-treatment department terminal 11 also functions as a report viewer terminal for the requesting doctor, displaying the inspection image 21 and the report 23 submitted from the inspection department 12. Consequently, the diagnosis-and-treatment department terminal 11, the report producing terminal 13, the image DB 22 and the report DB 24 constitute the report system as specified above in the summary of the invention. The report viewer terminal and the report DB 24 constitute the report viewer apparatus as recited in the summary of the invention.

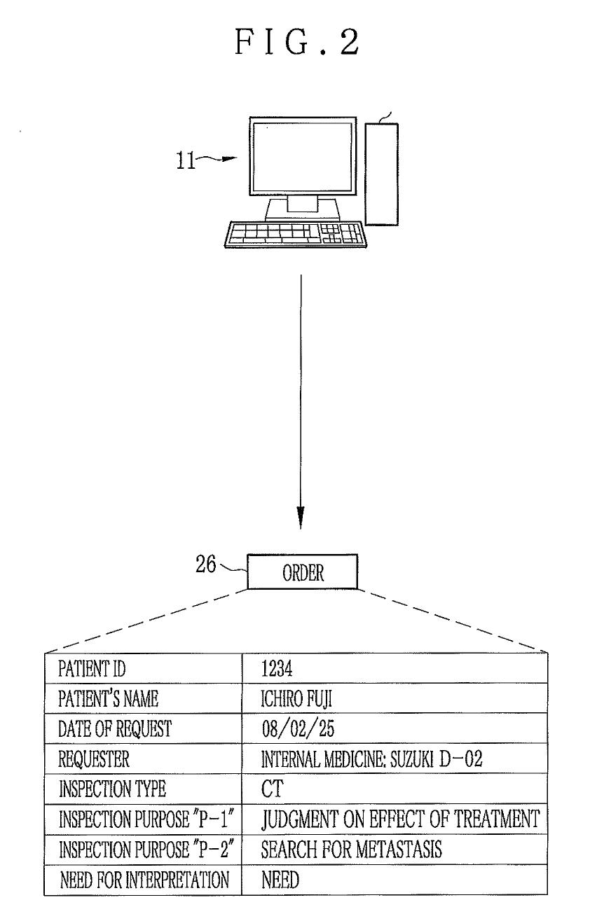

As shown in FIG. 2, an order 26 issued from the diagnosis-and-treatment department terminal 11 includes several items of information written in by the requesting doctor, including a patient ID, a patient's name, a request date, a requester, an inspection type like CT or MRI, inspection purposes and a need for radiological interpretation. As the item of the requester, information on the requesting doctor, such as its department, e.g. internal medicine, its name, e.g. Suzuki, and the doctor's ID, e.g. D-02, is recorded. In the present embodiment, two inspection purposes may be written in the order 26. In the illustrated example, ‘Judgment on therapeutic effect’ is written as a first purpose with a purpose ID P-1 and ‘Search for a metastasis’ is written as a second purpose with a purpose ID P-2.

The order 26 is sent to and received by an order receiving terminal that is not shown in the drawings but installed in the inspection department 12. After receiving the order 26, the order receiving terminal gives an inspection ID to the order 26 and manages the data of the order 26. The inspection ID is sent with an acknowledgment to the diagnosis-and-treatment department terminal 11. When the radiological interpretation is requested, that is, ‘Need’ is written in the item of the need for the radiological interpretation in the order 26, the order 26 is sent with the given inspection ID from the order receiving terminal to the report producing terminal 13. On the other hand, based on the order 26, staff at the inspection department 12 takes inspection images by the modality 19.

A radiological doctor checks the order 26 at the report producing terminal 13, reads the data of those inspection images 21 which are to be subjected to the radiological interpretation out of the image DB 22, and puts the result of interpretation of the inspection images 21 into a report 23. The data of the report 23 is stored in the report DB 24. At the completion of the report 23, the report producing terminal 13 sends an end notice to the diagnosis-and-treatment department terminal 11 of the requester. The end notice indicates addresses in the databases 22 and 24, where the data of the interpreted inspection images 21 and the report 23 of the interpretation are stored respectively. The requesting doctor gets an access to the addresses through the diagnosis-and-treatment department terminal 11, to retrieve and see the inspection images 21 and the report 23.

The respective terminals 11 and 13 and the respective DB servers 14 are configured based on computers such as a personal computer, a server computer or a workstation, by installing the computers with control programs such as a control program for an operating system and application programs such as client programs or server programs.

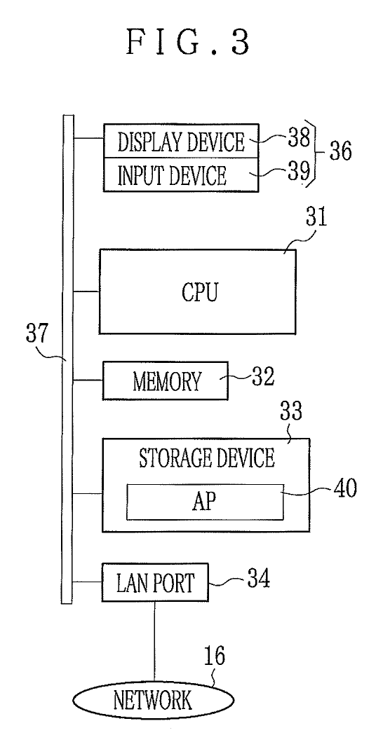

As shown in FIG. 3, the computers for the DB server 14 and the respective terminals 11 and 13 have the same basic structure, and are provided with a CPU 31, a memory 32, a storage device 33, a LAN port 34 and a console 36, all of which are connected via a data bus 37. The console 36 consists of a display 38 and an input device 39 such as a mouse and a keyboard.

The storage device 33 is, for example, a Hard Disk Drive (HDD) and stores the control program and the application program, hereinafter referred to as AP 40. Besides the HDD storing the programs, the server where the database is built up is provided with, for example, a disk array consisting of plural apposed HDDs as a storage device 33 for the database. The disk array can be built in a server body or arranged outside the server body and connected to the server body via a cable or a network.

The memory 32 is a work memory for the CPU 31 to carry out its processes. The CPU 31 controls the overall operation of every part of the computer by loading the control program as stored in the storage device 33 onto the memory 32 and performing the processes according to the program. The LAN port 34 is a network interface controlling transmission with the network 16.

The diagnosis-and-treatment department terminal 11 is installed with the client programs as the AP 40, such as software for reading or editing the chart 17 and viewer-software for displaying the inspection images 21 and the report 23. With the client program running, an operation screen is displayed by a Graphical User Interface (GUI) on a display device of the diagnosis-and-treatment department terminal 11. The operation screen includes display screens for displaying the chart 17, the inspection images 21 and the report 23, which are read from the chart DB 18, the image DB 22 and the report DB 24 respectively.

Operation commands are input to the diagnosis-and-treatment department terminal 11 through the console, to input or edit the chart 17 or to input or issue the order. Data of the input chart 17 and the input order 26 is stored in the chart DB 18.

The DB server 14 is installed as the AP 40 with a server program for executing some processes according to a client's request and responding the result of the process. When the server program gets active, the CPU of the DB server 14 functions as a storage processing section and a retrieval processing section for processing storage and retrieval of the data of the inspection images 21 and the report 23. The storage processing section performs a process of storing the data into the respective databases 22 and 24 according to the requests for storing the data from clients, that is, the report producing terminal 13 and the modalities 19. Responding to the request for delivering the inspection images 21 and the report 23, which is received from the diagnosis-and-treatment department terminal 11 or the report producing terminal 13, the retrieval processing section retrieves the data of the-requested inspection image 21 and report 23 from the respective databases 22 and 24, and delivers the retrieved data to the requester.

The report producing terminal 13 is installed as the AP 40 with a client program for report-editing that supports producing the report. With the client program for report-editing, the report producing terminal 13 executes a display process to the inspection image 21 in addition to an edit process to the report 23. As having a function of displaying the produced report 23, the report producing terminal 13 also functions as a report viewer terminal, like the diagnosis-and-treatment department terminal 11.

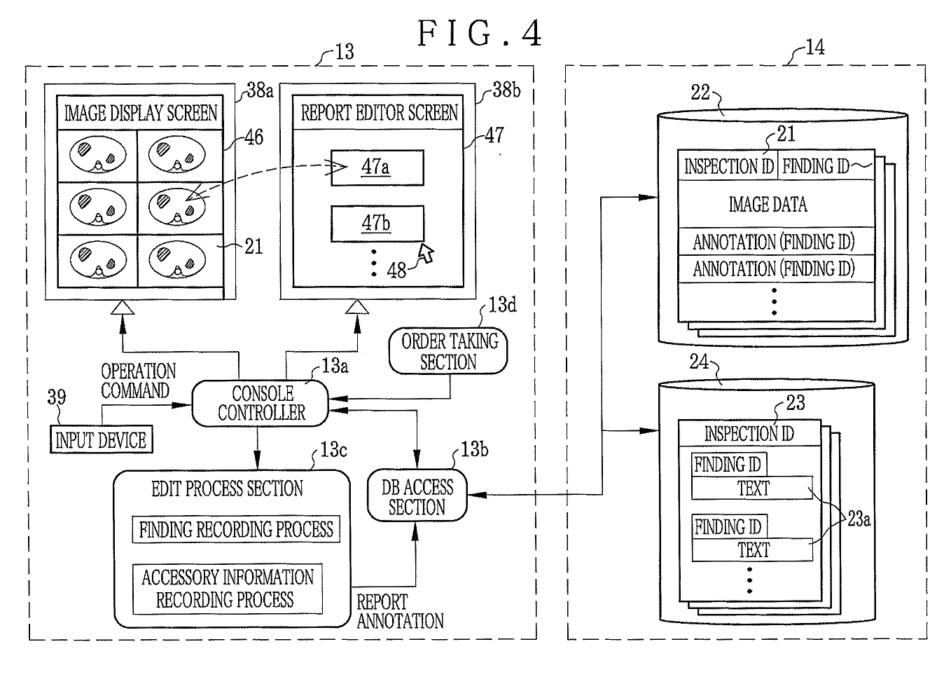

As shown in FIG. 4, the CPU 31 of the report producing terminal 13 functions as a console controller 13a, a DB access section 13b, an edit process section 13c and an order taking section 13d while the client program for report-editing is running. The order taking section 13d receives the order 26 from the order receiving terminal of the inspection department 12 via the network 16. The received order 26 is registered, for example, in an order table that is not shown in the drawings but built up in the storage device of the report producing terminal 13.

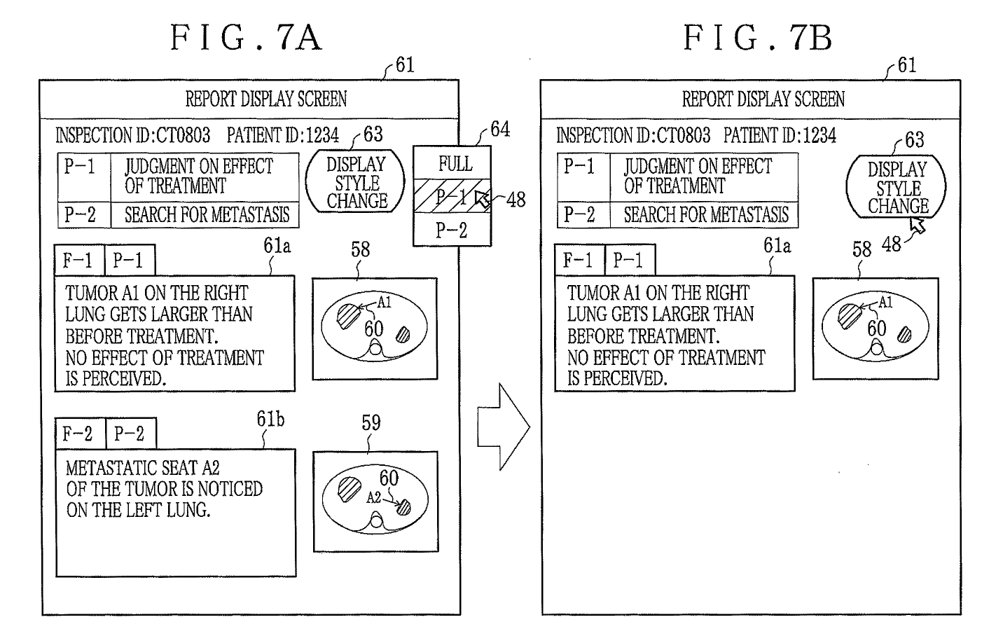

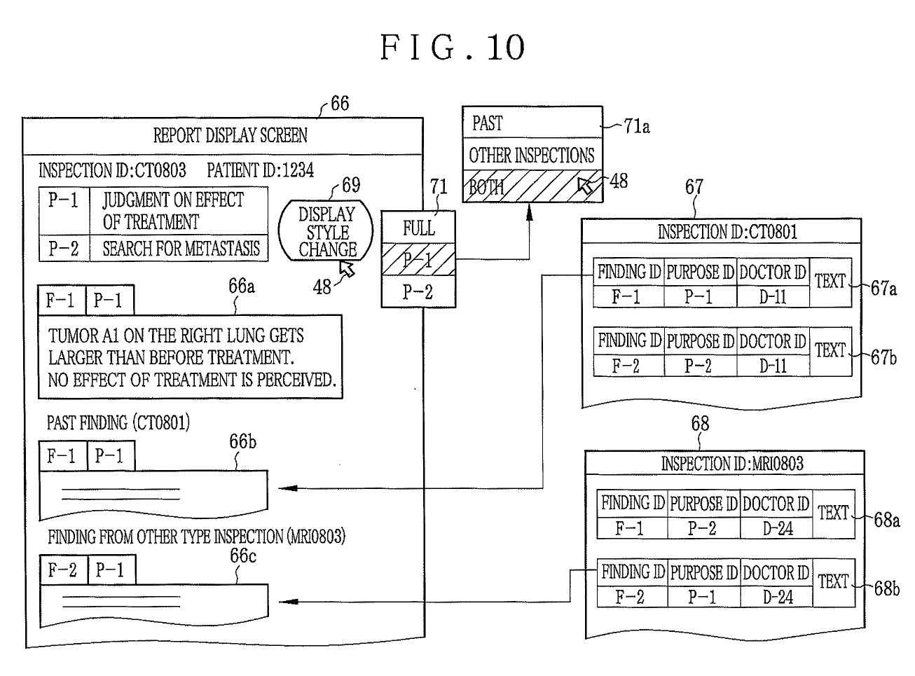

The report producing terminal 13 is, for example, a multi-display terminal, wherein two display devices 38a and 38b are connected to a terminal main body that is provided with the CPU 31. An image display screen 46 used for displaying the inspection images 21 is displayed on the display device 38a. On the other display device 38b, a report editor screen 47 and report display screens 61 and 66 (see FIGS. 7 and 10) are displayed. The report editor screen 47 is used for producing the report 23 and the report display screens 61 and 66 are used for displaying the produced report 23.

The image display screen 46 and the report editor screen 47 constitute the operation screens of the GUI. The console controller 13a outputs the operation screens onto the respective display devices 38a and 38b, and receives the operation commands from the input device 39 through the operation screens.

The image display screen 46 and the report editor screen 47 get active in cooperation with each other. For example, when an inspection ID is input on the report editor screen 47, which includes the inspection images 21 as the subject of the radiological interpretation, the console controller 13a obtains the data of the inspection images 21 corresponding to the input inspection ID from the image DB 22 through the DB access section 13b, and activates the image display screen 46 to output the obtained inspection images 21 on the display device 38a.

The image display screen 46 displays a variety of inspection images 21 such as radiologic perspective images taken by the CR device, tomograms taken by the CT scanner or the MRI machine, or three-dimensional images generated based on the tomograms. The image display screen 46 can display a plurality of the inspection images 21 at the same time, as like, for example, six tomograms are arrayed on one screen. The image display screen 46 is provided with various operation tools such as operation buttons, list boxes and icons, all of which constitute the GUI. By means of these operation tools, various operation commands are input by operating the input device 39.

The report editor screen 47 is provided with a plurality of entry areas 47a and 47b for the radiological doctors to enter their findings. In the respective entry areas 47a and 47b, various findings are written in, for example, by an intern doctor and an advising doctor, or by a doctor who made a primary radiological interpretation and a doctor who made a secondary radiological interpretation. It is possible to write different findings in the entry areas 47a and 47b corresponding to different inspection purposes as specified by the order 26. The findings written in the respective entry areas 47a and 47b are recorded as individual finding data 23a in the report 23 so that the findings can be treated individually.

The finding data 23a consists of text data which represent the text of the findings as written in the individual entry areas 47a and 47b, and accessory information attached to the text data, such as a finding ID, e.g. F-1 and F-2, that is given to the corresponding entry area 47a or 47b. As mentioned later, the respective finding IDs are added by the edit process section 13c.

Besides the respective entry areas 47a and 47b, the report editor screen 47 is also provided with various operation tools such as operation buttons, list boxes and icons, all of which constitute the GUI, in the same way as the image display screen 46. By means of the operation tools, the various operation commands are input by operating the input device 39.

The operation commands include a command to read the data of the report 23 from the report DB 24, a command to store the data of the report 23 in the report DB 24, a command to select any of the entry areas 47a and 47b, a command to make the selected entry area active to permit writing the text therein, and a command to store the data 23a of the entered findings.

For example when a pointer 48 of the mouse points and clicks on one of the entry areas 47a and 47b , the one entry area gets active. In the activated one of the entry areas 47a and 47b, a caret or character entry pointer flashes to indicate a position for entering the text. Thus, the radiological doctor makes the entry area active and then enters the text of findings by operating the input device 39.

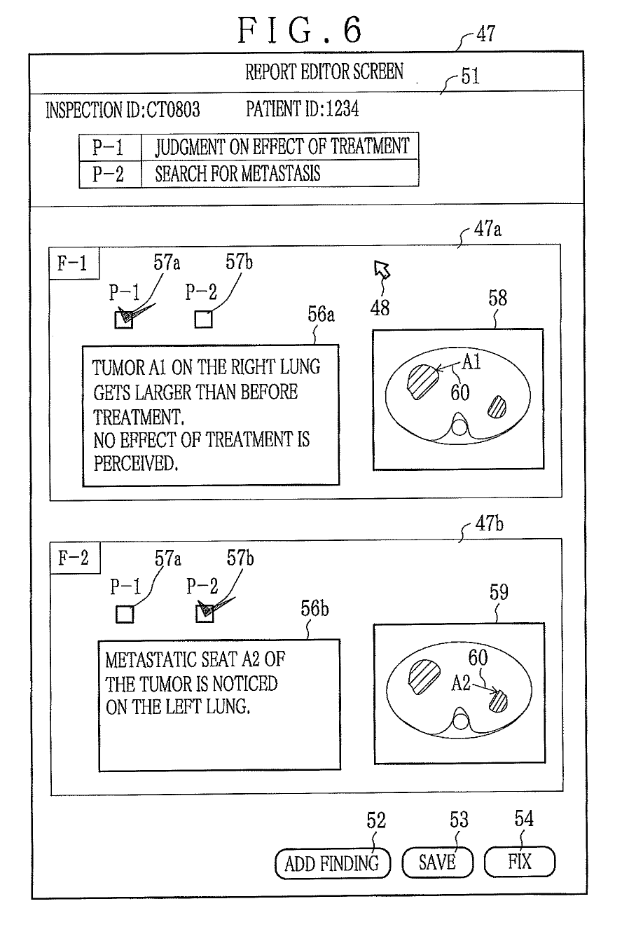

On producing the report 23, it is also possible to perform such processing as adding an annotation 60 (see FIG. 6) to the inspection image 21 displayed on the image display screen 46. The annotation 60 is put by the radiological doctor to an area of interest, e.g. a pathological lesion, in the inspection image 21. The annotation 60 is composed of various objects, such as marks and text boxes, including an arrow indicating the area of interest, a circle and characters or letters, and a rectangular or balloon text box for inserting simple comments. The annotation 60 may consist of the marks alone or the text box alone.

Moreover, it is also possible to link the respective findings entered in the respective entry areas 47a and 47b with the inspection images 21 displayed on the image display screen 46, while making the report 23 on the report editor screen 47. As shown by a dashed arrow in the FIG. 4, the linkage of the finding with the inspection image 21 is made, for example, by pointing to any of the entry areas 47a and 47b on the report editor screen 47 by the pointer 48 of the mouse and then moving the pointer 48 toward the inspection image 21 to be linked with on the image display screen 46, that is a drag-and-drop operation by the mouse.

It is possible to link one finding with more than one inspection image 21. It is also possible to link one inspection image 21 with more than one finding.

After the linkage is made, the finding ID of the linked finding is added to the data of the linked inspection image 21. By this procedure, it becomes possible to retrieve the inspection image 21 using the finding ID as the search key, which makes it easy to read out the linked inspection image 21 with the corresponding finding, and display the linked inspection image 21 on the image display screen 46. The finding ID added to the inspection image 21 increases according to the number of findings linked to it. For example, if one finding is linked to one inspection image 21, one finding ID is attached to the inspection image 21. If two findings are linked to one inspection image 21, two finding IDs are attached to the inspection image 21.

The console controller 13a receives an operation command to add the annotation to the inspection image 21 or an operation command to link the inspection image 21 with the finding, and orders the edit process section 13c to perform the process according to the operation command.

The DB access section 13b sends requests for processing to the DB server 14 and receives the result of processing from the DB server 14, according to the commands from the console controller 13a and the edit process section 13c. The requests for processing sent to the DB server 14 are addressed to the image DB 22 or to the report DB 24. The requests for processing to the image DB 22 include a retrieval request for retrieving the inspection image 21 by means of a search key such as the inspection ID or the image ID, and a storage request for storing the accessory information, such as the annotation and the finding ID, which is attached to the inspection image 21 on the report producing terminal 13, in association with the inspection image 21. The requests for processing to the report DB 24 include a retrieval request for retrieving the data of the report 23 by means of a search key such as the inspection ID, the finding ID or an after-mentioned purpose ID, and a storage request for storing the data of the edited report 23.

The DB access section 13b receives the data of the edited report 23 from the edit process section 13c in response to the storage request, and sends the data to the DB server 14. The DB access section 13b also receives the data as retrieved in response to the retrieval request from the DB server 14, and delivers the retrieved data to the console controller 13a.

The edit process section 13c executes a finding recording process and an accessory information recording process. In the finding recording process, the edit process section 13c receives the findings as entered in the entry areas 47a and 47b through the console controller 13a. The edit process section 13c sorts the received text data of the findings into individual blocks for the respective entry areas 47a and 47b, gives the finding ID, such as F-1 or F-2, to each block of the text data, and records them as the finding data 23a.

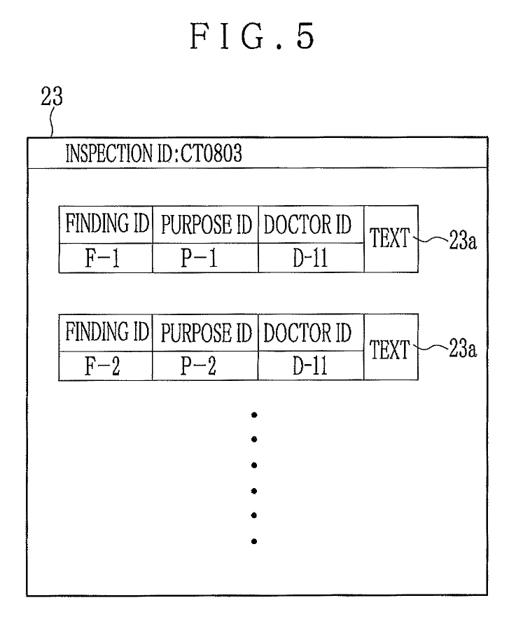

As shown in FIG. 5, the edit process section 13c also adds to each finding data 23a a doctor ID, e.g. D-02, for identifying the radiological doctor who entered the finding, and the purpose ID, e.g. P-1 or P-2, corresponding to the inspection purpose, in addition to the text of the finding and the finding ID, e.g. F-1 or F-2, in the finding recording process.

Adding the purpose ID to the finding data 23a establishes a linkage between the inspection purpose and the individual finding. In other words, the edit process section 13c is a linking device to link the individual finding with the inspection purpose. These IDs are used as search keys for retrieving the finding data 23a. The doctor ID is input by the radiological doctor for user-authentication that is required, for example, for activating the report producing terminal 13. Besides, the inspection ID, e.g. CT0803, the patient ID and the patient's name, which are read out from the order 26, are added to the data of the report 23.

The accessory information recording process is a process of recording the accessory information, including the annotation and the finding ID, in the image DB 22, in association with the inspection image 21, which the accessory information is attached to. For example, the finding ID and the data of the annotation 60 are recorded in the data of the inspection image 21.

Aside from the inspection image 21, the data of the annotation 60 is also linked with the finding by adding the finding ID to the respective annotation data. For example, when there are pathological lesions in one inspection image 21 and the findings are entered individually about the respective pathological lesions, the annotations pointing the pathological lesions are different from one finding to another.

As described later, the annotation 60 is linked with the finding for the sake of switching the display of the annotation on the report display screen 61 in accordance with the selected finding. The linkage between the annotation 60 and the finding is made for example while the annotation 60 is being inserted into the inspection image 21 on the image display screen 46, by adding the finding ID, which corresponds to the entry area that is active during the insertion of the annotation 60, to the data of the inserted annotation 60.

As shown in FIG. 6, the report editor screen 47 is provided with a basic information display area 51 placed in an upper zone of the screen, the entry areas 47a and 47b arranged below for entering the respective findings (F-1 and F-2), and the operation buttons 52, 53 and 54. In the basic information display area 51, the basic information including the inspection ID (CT0803), the patient ID (1234) and the inspection purposes (P-1, P-2) are displayed. The basic information is read out from the order 26. The present embodiment is based on the assumption that the order 26 is recorded with two inspection purposes: ‘Judgment on therapeutic effect’ and ‘Search for a metastasis’. So the content of the respective inspection purposes are displayed in association with the corresponding purpose IDs “P-1” and “P-2” on the report editor screen 47: the purpose ID “P-1” is assigned to the purpose of ‘Judgment on therapeutic effect’, and the purpose ID “P-2” is assigned to the purpose of ‘Search for a metastasis’.

The respective entry areas 47a and 47b are provided with text entry boxes 56a and 56b for inputting the texts of the findings and check boxes 57a and 57b for designating the inspection purpose to be linked with the finding. By designating the inspection purpose, a command to link the designated inspection purpose with the finding is given to the edit process section 13c. The check boxes 57a and 57b are equivalent to the first operation tool as specified above in the summary of the invention.

The check boxes 57a and 57b are the operation tool constituting the GUI and switches on and off by clicking the mouse thereon. The number of the check boxes changes according to the number of the inspection purposes recorded in the order 26. In the illustrated embodiment, two inspection purposes are recorded in the order 26, so two check boxes 57a and 57b are provided in each entry area 47a or 47b, and the purpose IDs “P-1” and “P-2” for the respective inspection purposes are displayed on the upper side of the check boxes 57a and 57b respectively.

Since the purpose ID “P-1” is assigned to the purpose of ‘Judgment on therapeutic effect, when the radiological doctor writes a finding regarding judgment on therapeutic effect in the entry area 47a, whose finding ID is F-1, the radiological doctor checks the check box 57a with the purpose ID “P-1” by clicking the mouse thereon in the entry area 47a. Thereby, the inspection purpose to be linked with the written finding is designated, and the command to link the finding with the designated inspection purpose is given to the edit process section 13c.

Moreover, it is possible to insert and paste key images 58 and 59 in the respective entry areas 47a and 47b. The key image 58 or 59 is an inspection image 21 that has a relation to the finding as written in the text entry box 56a or 56b respectively. The key images 58 and 59 are selected from among the inspection images 21 by the radiological doctor, as such images that the radiological doctor paid special attention to or had special interest in on entering the respective findings. According to this embodiment, the annotation 60 made of a code A1 or A2 representative of an area of interest and an arrow pointing the area of interest is inserted in the key image 58 or 59, respectively.

An operation button 52 is a button for adding another entry area to enter another finding. Upon clicking the mouse with the pointer 48 on the add button, the entry area is added to the report editor screen 47. An operation button 53 is a save button for temporarily storing the data of an unfinished report 23. An operation button 54 is a fix button for fixing and storing the data of a finished report 23. Edition of the fixed report 23 is prohibited in order to prevent unfair alteration of the report 23.

A report display screen 61 shown in FIG. 7 is for displaying the content of the report 23, wherein FIGS. 7A and 7B show two examples of display conditions on the report display screen 61. The report display screen 61 is used for the requesting doctor to view the report 23, and is displayed on the display devices of the report producing terminal 13 and the diagnosis-and-treatment department terminals 11, which function as the report viewer terminals while displaying the report display screen 61.

The report producing terminal 13 receives the data of the report 23 on the DB access section 13b. The console controller 13a produces the report display screen 61 to display the received report 23 and outputs it on the display device 38b. The report producing terminal 13 interlocks the image display screen 46 with the report display screen 61 in the same way as the report editor screen 47 and displays it on the display devices 38a and 38b respectively. The console controller 13a is an equivalent for the first and second console controlling devices as specified above in the summary of the invention.

As for the display process of the report display screen 61 and the image display screen 46, the CPU 31 of the diagnosis-and-treatment department terminal 11 functions in the same way as the console controller 13a and the DB access section 13b of the report producing terminal 13 do. In other words, the CPU 31 of the diagnosis-and-treatment department terminal 11 is an equivalent for the second console controlling device. Where the diagnosis-and-treatment department terminal 11 has only one display device, the report display screen 61 and the image display screen 46 are apposed on the one display device.

On the report display screen 61, the basic information, including the inspection ID and the inspection purpose recorded in the order 26, is displayed in the same way as the report editor screen 47. The report display screen 61 is provided with display areas corresponding to the respective entry areas 47a and 47b. The respective display areas are provided with display fields 61a and 61b for displaying the respective contents of the finding data 23a of the report 23 and also display the key images 58 and 59. In the display fields 61a and 61b, the finding IDs, F-1 and F-2, and the purpose IDs, P-1 and P-2, are displayed in addition to the contents of the finding data 23a, as these IDs are attached to the finding data 23a through the linking process. These displays clearly show the correspondence between the respective findings and inspection purposes in the respective display fields 61a and 61b.

The report display screen 61 is also provided with a display style change button 63. The display style change button 63 is an operation tool for giving an operation command to change the display style of the findings displayed on the report display screen 61. The display style change button 63 is equivalent to the second operation tool as recited above in the summary of the invention.

When the command to change the display style is given through the display style change button 63, the CPU 31 of the diagnosis-and-treatment department terminal 11 or the console controller 13a executes the process of changing the display style of the finding. As described below, the display style changing process allows restricting the scope or range of the findings to be displayed on the report display screen 61. The CPU 31 of the diagnosis-and-treatment department terminal 11 and the console controller 13a are equivalent to a display change processing device as recited above in the summary of the invention.

Upon clicking the mouse with its pointer 48 on the display style button 63, a select menu 64 pops up. The select menu 64 contains several option items: an item ‘Full’ and items representative of purpose IDs P-1 and P-2. The item ‘Full’ is for selecting a full display style, displaying all findings contained in one report 23. The items of the purpose IDs are for displaying only those findings which relate to the inspection purpose identified by the selected purpose ID, P-1 or P-2, among the findings in the report 23. That is, the items of the purpose IDs are for selecting a refined display style. The report display screen 61 may be initially set to the full display style.

When the item ‘Fill’ is selected by clicking it on, all the findings in the report 23 are displayed, as shown in the report display screen 61 in FIG. 7A. When the item of the purpose ID P-1 or P-2 is selected in the select menu 64, the CPU 31 of the diagnosis-and-treatment department terminal 11 or the console controller 13a executes a refinement process of restricting the findings to be displayed on the report display screen 61 by the inspection purpose. When the item of P-1 is selected, only the finding having the purpose ID of P-1 is displayed on the report display screen 61, as shown in FIG. 7B. In the same way, when the item of P-2 is selected, only the finding having the purpose ID of P-2 is displayed.

When the item of the purpose ID P-1 or P-2 is selected in the select menu 64, the console controller 13a or the CPU 31 of the diagnosis-and-treatment department terminal 11 extracts the finding data 23a associated with the selected purpose ID, using the selected purpose ID as the search key, and narrows down the number of the findings to be displayed on the report display screen 61.

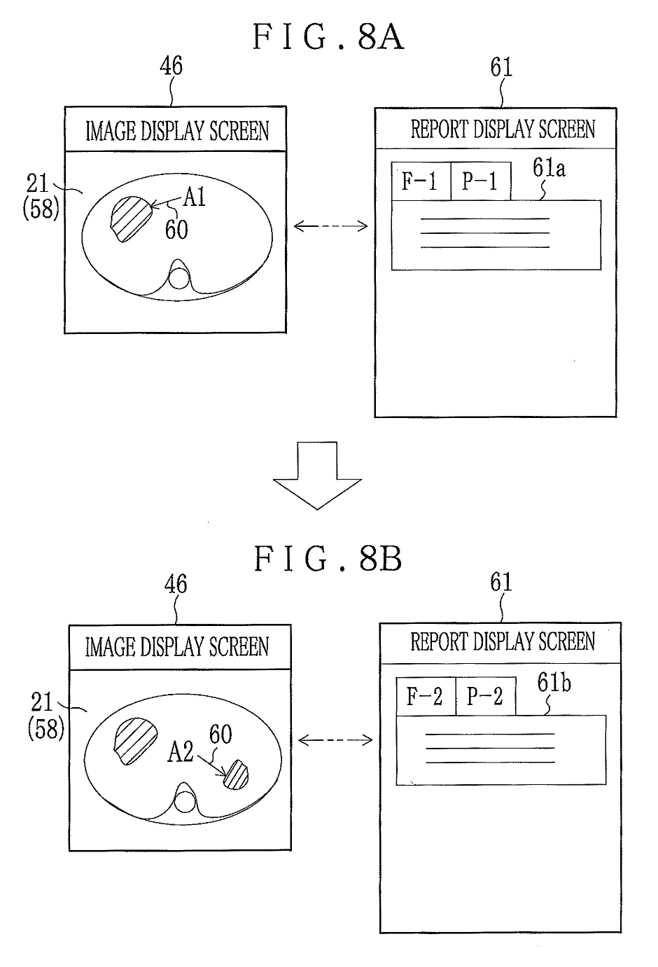

As shown in FIG. 8, when the display style of the report display screen 61 is changed, the content displayed on the image display screen 46 is also changed in correspondence with the change in the display style. For example, when the narrowed display is selected in the select menu 64 to restrict the scope of the displayed findings to the inspection purpose identified by the ID of P-1, the report display screen 61 shows only the finding having the ID of F-1 as it is associated with the purpose ID of P-1, and the inspection image 21 linked with the finding F-1 is displayed on the image display screen 46, as shown in FIG. 8A. The inspection image 21 includes the key image 58 inserted in the report 23 in relation to the finding F-1.

When a plurality of the inspection images 21 are linked with the finding F-1, the inspection images 21 linked with the finding F-1 are displayed seriatim in response to a switching operation for switching the inspection image on the image display screen 46. Moreover, when the annotation 60 is added to the inspection image 21, the inspection image 21 is displayed with the annotation 60 on the image display screen 46.

As shown in FIG. 8B, when the item of the purpose ID of P-2 is selected on the select menu 64, the report display screen 61 shows only the finding whose purpose ID is P-2, i.e. the finding with the finding ID of F-2 in this embodiment. Then, the content to be displayed on the image display screen 46 switches to the inspection image 21 linked with the finding F-2 in synchronism with the change of the report display screen 61. Since the annotation 60 is inserted in the inspection image 21 relating to the finding F-2, the annotation 60 is also displayed with the inspection image 21.

As described above, the finding ID is added to the data of the annotation 60. Therefore, when a plurality of annotations 60 with different finding IDs are inserted into one inspection image 21, the inspection image 21 remains unchanged, and only the displayed annotation 60 changes over in sync with the change in display style of the findings, to switch the contents displayed on the image display screen 46.

When the item of ‘Full’ is selected in the select menu 64 and all the findings are displayed on the report display screen 61, the image display screen 46 shows the inspection images 21 corresponding to the inspection ID of the report 23. In the FIGS. 8A and 8B, the image display screen 46 shows only one inspection image 21 at a time, but the image display screen 46 may display a plurality of inspection images 21 side by side.

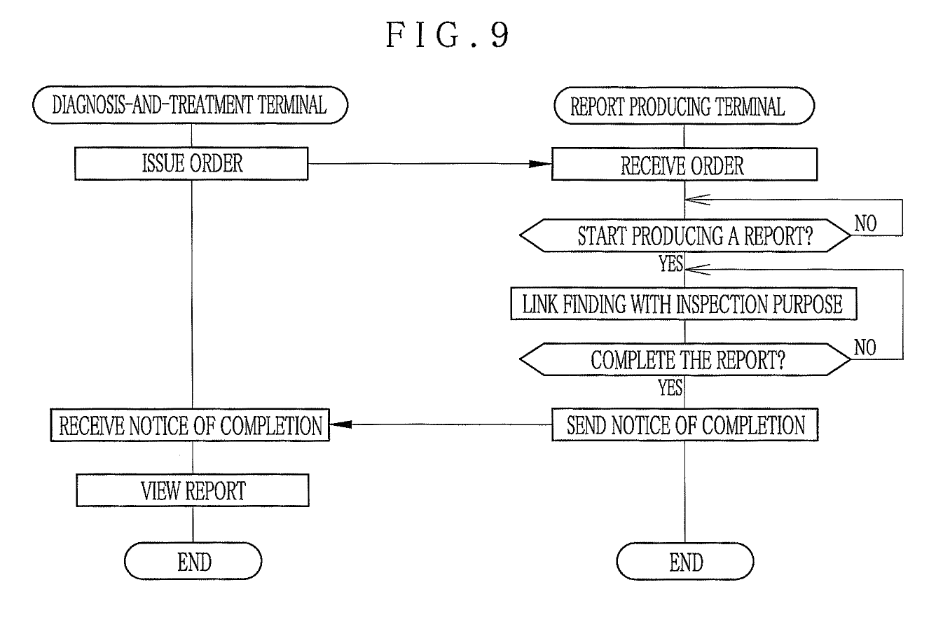

Next, the operation of the above described embodiment will be explained, while referring to the flowchart shown in FIG. 9. The requesting doctor uses the diagnosis-and-treatment department terminal 11 to issue the order 26. The report producing terminal 13 receives the order 26 sent from the diagnosis-and-treatment department terminal 11 through the order receiving terminal at the inspection department 12.

The radiological doctor checks the order 26 at the report producing terminal 13 and starts making the report 23. When the report editor screen 47 is displayed on the display device 38b, the image display screen 46 is displayed on the display device 38a in conjunction with the display device 38b. The basic information display area 51 on the report editor screen 47 displays the contents of the plural inspection purposes, such as Judgment on therapeutic effect and Search for a metastasis, which are read out from the order 26. The radiological doctor checks the inspection purposes on the report editor screen 47 and enters the findings according to the respective inspection purposes into the respective entry areas 47a and 47b, while observing the inspection images 21 on the image display screen 46.

The text data of the findings entered from the respective entry areas 47a and 47b is given the finding ID corresponding to the respective entry areas 47a and 47b, and is recorded as the finding data 23a in the data of the report 23 respectively. When the command to link the respective findings with the inspection purpose is given through the check boxes 57a and 57b in the respective entry areas 47a and 47b, the console controller 13a sends the purpose ID corresponding to the selected check box 57a or 57b to the edit process section 13c. The edit process section 13c adds the received purpose ID to the finding data 23a one by one. This procedure links the finding with the inspection purpose.

When the edit process section 13c receives the command to store the report 23, the edit process section 13c adds the inspection ID to the report 23 and stores the data in the report DB 24. When the edit process section 13c receives the command to link the respective findings with the inspection image 21 through the image display screen 46 and the report editor screen 47, the edit process section 13c executes the accessory information recording process to add the finding ID to the inspection image 21. Moreover, when the annotation 60 is inserted in the inspection image 21, the edit process section 13c also executes the accessory information recording process, to add the finding ID to the data of the annotation 60 and record the annotation data with the data of the inspection image 21 in the image DB 22.

At the completion of the report 23, the report producing terminal 13 sends the end notice to the diagnosis-and-treatment department terminal 11 of the requesting doctor. The diagnosis-and-treatment department terminal 11 gets an access to the report DB 24 on the basis of the address of the report 23 as indicated in the end notice, to read out the report 23. Then, the report display screen 61 and the image display screen 46 displaying the inspection image 21 relating to the report 23 are output on the display device of the diagnosis-and-treatment department terminal 11.

The requesting doctor reads the content of the report 23 on the report display screen 61 and views the inspection image 21 related to the report 23 on the image display screen 46. Because the report 23 has the linkage between the findings and the inspection purposes, the respective display fields 61a and 61b display the findings corresponding to the respective inspection purposes, as shown on the report display screen 61 in FIG. 7A. The respective display fields 61a and 61b are attended by the respective purpose IDs, e.g. P-1 and P-2, showing the correspondence between the inspection purpose and the finding distinguishably. Therefore, even where one report 23 contains multiple findings according to different inspection purposes, the requesting doctor can clearly grasp the correspondence between each individual finding and the inspection purpose thereof.

On the report display screen 61, the contents of the inspection purposes such as Judgment of therapeutic effect and Search for a metastasis, which are read out from the order 26, are also displayed corresponding to the purpose IDs. Therefore, it is unnecessary to check the content of the order 26 on a different screen from the report display screen 61.

When the requesting doctors want to view the findings in the refined display style showing merely those findings which relate to one inspection purpose, they operate the display style change button 63 on the report display screen 61 and give the command to change the display style of the report display screen 61, as shown in the FIG. 7. When the mouse selects the item of one inspection purpose ID, P-1 or P-2, in the select menu 64, the command to change the report display screen 61 to the refined display style is input by operating the input device 39. The CPU 31 of the diagnosis-and-treatment department terminal 11 extracts the finding data 23a having the selected purpose ID from the data of the report 23, using the selected purpose ID as the search key, and displays only the extracted finding data 23a on the report display screen 61, as shown in the FIG. 7B.

Through this procedure, only those findings which are associated with the selected purpose ID are displayed on the report display screen 61, so that the requesting doctor can grasp more clearly the correspondence between the finding and the inspection purpose. Moreover, because the report display screen 61 can switch the display style between one displaying all findings contained in the report 23 and one displaying winnowed findings in the report 23, the requesting doctor can select the display style according to the purposes of consulting the findings, which improves accessibility and visibility of the reports 23.

The check boxes 57a and 57b provided in the respective entry areas 47a and 47b on the report editor screen 47 originally serve the function of giving the command to link the finding with the inspection purpose. In addition to the original function, the check boxes 57a and 57b also serve for preventing the radiological doctor from failing to enter the findings that answer all the inspection purposes the requesting doctor expects, as well as for preventing the entered finding from being at variance with the inspection purpose.

In other words, providing the check boxes 57a and 57b gives the radiological doctors who enter their findings in the respective entry areas 47a and 47b an opportunity to double-check whether they have entered their findings for all the inspection purposes that the requesting doctor expects, or which purpose the entered content of the finding answers. This prevents the above-mentioned mistakes: ensuring entry of the findings for all the requested inspection purposes, and preventing the entered finding from being at variance with the inspection purpose.

Moreover, since the contents of the inspection purposes specified in the order 26, e.g. Judgment on therapeutic effect, or Search for a metastasis, are displayed in the basic information display area 51, the radiological doctor can save the trouble of checking the content of the order 26 on a different screen from the report editor screen 47, which is convenient for the radiological doctor.

Providing the respective entry areas 47a and 47b with the check boxes 57a and 57b on the report editor screen 47 is helpful to prevent producing such a report that is unclear about the correspondence between the finding and the inspection purpose and inferior in the efficiency of consultation, regardless of the radiological doctors' skill of producing the report.

Namely, even if it is required to enter multiple findings in a single entry area to answer the plural inspection purposes, radiological doctors skilled in reporting can put the correspondence between the respective inspection purposes and the findings orderly into the report. However, the reports produced by unskilled radiological doctors are likely to show poor correspondence between the findings and the inspection purposes. Since the check boxes 57a and 57b are provided in the respective entry areas 47a and 47b, the respective entry areas 47a and 47b for the findings double as the entry areas for the individual inspection purposes, so the content of the finding written in one entry area can be limited to the content corresponding to the one inspection purpose. Since the entry areas for the findings are sectioned by the inspection purpose in this way, the radiological doctor can produce the report with clear correspondence between the findings and the inspection purpose, even with low reporting skill.

In the above described embodiment, the report display screen shows the findings contained in one report. It is, however, possible to display those findings which are read out from different reports on a report display screen. In this case, the process of changing the display style on the report display screen is executed for the respective reports.

A report display screen 66 shown in FIG. 10 is an example of the screen displaying findings read out from different reports. The report display screen 66 is originally displaying a report 23 whose inspection ID is CT0803, but also displays findings 66b and 66c contained in other reports 67 and 68, of which inspection IDs are CT0801 and MRI0803 respectively, in addition to a finding 66a in the report 23. For example, the reports 67 and 68 relate to the same patient as the report 23.

In the present example, the report 67 is a past report made about the same type of inspection as the report 23 relates to, e.g. CT scanning, pretty before the report 23 was made. The report 68 is a report about a different type of inspection from the report 23 relates to, e.g. MRI scanning, but the report 68 was made in the same period as the report 23. Of course, the report 68 can be the past report of the different inspection from the inspection for the report 23. In the report 67, finding data 67a and 67b for different inspection purposes are recorded and identified with purpose IDs P-1 and P-2. Likewise, finding data 68a and 68b for different inspection purposes are recorded with purpose IDs P-1 and P-2 in the report 68.

Like the display style change button 63 in the above described first embodiment, a display style change button 69 arranged on the report display screen 66 is an operation tool for giving an operation command to change the display style of the report display screen 66. Clicking a mouse with its pointer 48 on the display style button 69 lets a select menu 71 pop up. Like the select menu 64 according to the above described first embodiment, the select menu 71 has items to select the display style between the full display style for displaying all the findings contained in the report 23, and a refined display style for displaying a limited number of findings as refined by the inspection purpose. When either the item P-1 or P-2 is selected for the refined display style, a sub menu 71a is displayed.

In the sub menu 71a, several items are displayed as options to select the range of reports to be subjected to a refined search process that is included in the display style changing process. The item ‘Past’ is selected when the past reports are to be included in the subject of the refined search process. The item ‘Other inspections’ is selected when the reports on other kinds of inspections are to be included in the subject of the refined search process. The item ‘Both’ is selected when both the past reports and the reports of other kinds of inspections are to be included in the subject of the refined search process.

FIG. 10 shows an example where the refined display style is selected to display those findings whose purpose ID is P-1 and the item ‘Both’ is selected for the scope of reports to be subjected to the refined search process. According to the command to change the display style of the selected content, a CPU 31 of a diagnosis-and-treatment department terminal 11 or a console controller 13a of a report production terminal 13 executes the refined search process that refines the search targets by the inspection purpose. Using a patient ID and a purpose ID as search keys for the refined search process, those findings which match with the search keys are retrieved from the past reports and the reports of other kinds of inspections, which are stored in a report DB 24. The retrieved findings are displayed on the report display screen 66.

A display field 66a on the report display screen 66 displays a finding that is contained in the report 23 and is attended by the purpose ID of P-1. A display field 66b displays a finding that is contained in the report 67 and is attended by the purpose ID of P-1. A display field 66c displays a finding that is contained in the report 68 and is attached by the purpose ID of P-1.

As the refined search for the findings is executed across many reports, it comes to be possible to display the findings with the common inspection purpose, which are contained in the past reports and the reports of other kinds of inspections, together on the report display screen 66. Since various findings with the common inspection purpose get visible at once, the report display screen 66 of the second embodiment show the reports in a more comprehensible manner as compared to the above described first embodiment.

In the above described embodiment, reports on the same patient are the target of the refined search process. However, it is possible to execute the refined search process across many reports on different patients, for example, for the sake of comparing the reports on those patients having similar diseases to each other. In this case, for example, the information on disease is used as a keyword for retrieval of the findings in addition to the purpose ID.

In the above described embodiment, the display style on the report display screen is selected between the full style displaying all the findings in the report and the refined display style displaying only those findings which relate to a designated inspection purpose. In addition to or instead of the refined display style, it is also possible to select a sorted display style wherein the findings are displayed in groups sorted by inspection purposes.

In a case where only one finding corresponds to one inspection purpose, like as the above described first embodiment, it has no meaning to sort by inspection purposes. But in a case where there are many findings related to one inspection purpose, sorting the findings by the purposes ID as sort keys allows these findings with the common inspection purpose to be displayed in a unit without being dispersed, which makes them easy-to-follow.

The subject of the sorting process for displaying the findings in the sorted display style on the report display screen may also be a plurality of reports, not only a single report, like the refined search process.

Besides the above-described refined display style and the sorted display style, the report display screen may have such a display style that emphasizes some findings. As a method of emphasizing the findings, it is possible to change the color of the text or background of the finding with a particular inspection purpose to differentiate from the findings with other inspection purposes, or carry out a shading process. It is also possible to display a mark in a display area of a target finding, indicating that this finding is important.

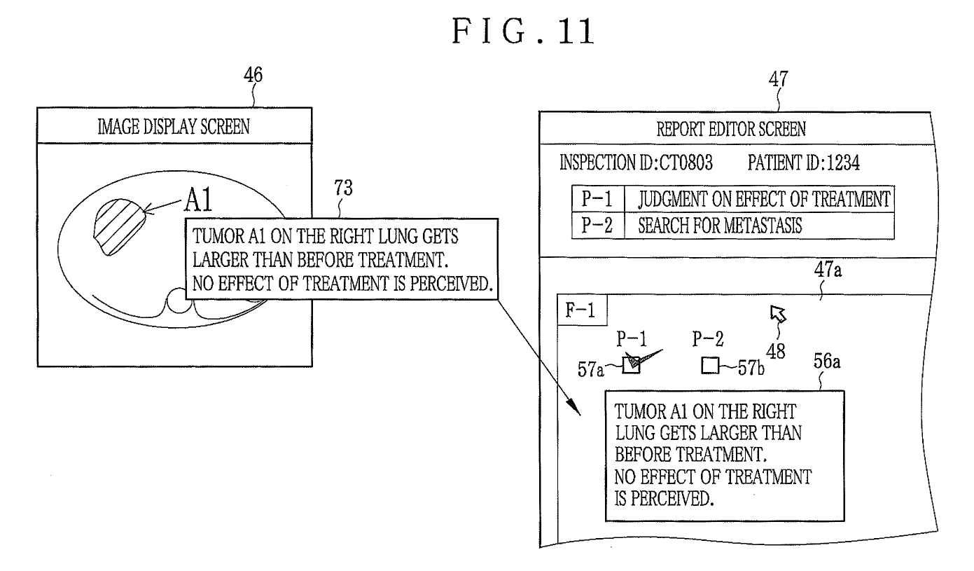

In the above described embodiment, the finding is written in on the report editor screen 47, but it is possible to insert an entry box in the image display screen 46 and write a finding in the entry box on the image display screen 46, as written in the above described prior art (JPA 2005-025669). In this embodiment, as shown in FIG. 11, when the finding is entered in an inserted entry box 73 on the image display screen 46, a console controller 13a of a report producing terminal 13 automatically imports the finding written in the entry box 73 into an entry area 47a on the report editor screen 47.

In the above described embodiments, the CPU 31 of the diagnosis-and-treatment department terminal 11 or the report producing terminal 13 individually carries out the display style changing process for the report display screen 61 or 66, including the refined search process and the sorting process. It is, however, possible for the DB server 14 to take part in the display style changing process. In this case, the CPU 31 of the DB server 14 constitutes the display change processing device.

For example, in a system where the DB server 14 transforms the data of the report display screen 61 or 66 containing the data of the report 23 into a Web page, i.e. page-data in which source codes are described by such markup language as Extensible Markup Language (XML), and delivers it to the report producing terminal 13 or the diagnosis-and-treatment department terminal 11, the DB server 14 carries out the refinement process or the sorting process in response to the request from the diagnosis-and-treatment department terminal 11 or the report producing terminal 13.

More specifically, when the data of the report 23 is reread out of the DB server 14 every time the command to change the display style is given by the display style change button 63 or 69, the report producing terminal 13 or the diagnosis-and-treatment department terminal 11 sends the DB server 14 a request for retrieval with key information, such as the inspection ID or the purpose ID as the search key or the sort key. The DB server 14 reads out the key information from the retrieval request to retrieve the finding data of the relevant report from the report DB 24. The DB server 14 then converts the retrieved finding data to the Web page format and delivers it to the requester, the report producing terminal 13 or the diagnosis-and-treatment department terminal 11.

The report producing terminal 13 or the diagnosis-and-treatment department terminal 11 interprets the source code of the received Web page through client software for viewing the report or through a generalized browser, to produce the report display screen 61 or 66 and output them to the display device.

In the above described embodiment, the report display screen is provided with the display style change button to change the display style of the report display screen. It is, however, possible to provide the report editor screen with a display style change button so as to permit changing its display style half-way through the report making.

In the above described embodiment, the purpose ID is added to the finding data to link the finding with the inspection purpose. It is alternatively possible to record the correspondence between the purpose ID and the finding ID as table data in a linkage process, separately from the finding data.

In the above described embodiment, every finding is linked with one or more than one inspection purpose. However, at least one of the plural findings may be linked with one inspection purpose. For example, when only one inspection purpose is specified and the radiological doctor enters one finding in response to the desired inspection purpose and adds another finding as a personal remark, the former is linked with the inspection purpose, but the latter is not linked with the inspection purpose. Even in this case, the report contains the different findings as viewed by the requesting doctor. When the requesting doctor searches for the finding that answers the desired inspection purpose, the linkage between the inspection purpose and the finding facilitates the retrieval.

In the above described embodiment, the explained example of the report contains two findings, but, of course, it can contain more than two findings. The number of entry areas on the report editor screen and the number of display areas on the report display screen are equal to each other. The above embodiments have been described on the assumption that one radiological doctor produces one report. It is, of course, possible for two or more radiological doctors to cooperate in producing one report by writing their respective findings in the one report.

In the above described embodiment, the examples of the inspection purpose are ‘Judgment on therapeutic effect’ and ‘Search for a metastasis’. Of course, the inspection purpose is not limited to these ones. Aside from the above described ones, there may be such inspection purposes as ‘Scrutinizing’, ‘Differential diagnosis between benign and malignant’, ‘Follow-up’, ‘Staging’ for examining the stage of progress of the disease, ‘Diagnosis of recurrence’ for checking up on recurrence of the disease and ‘Search for a primary focus’ for searching for a primary focus of a disease such as a primary tumor of cancer.

In the above described embodiment, the command to link the inspection purpose with the finding is given by specifying the inspection purpose at the check box. However, the operation tool for giving the linkage command is not limited to the check box, but may be another operation tool such as a list box displaying selectable inspection purposes in a list.

Instead of the operation tool, it is also possible for the radiological doctor to enter the inspection purpose in the form of a text and to add the entered text itself to the finding data as the purpose ID. It is also possible to determine the inspection purpose by recognizing the entered text and then convert it to a preregistered purpose ID according to the result of determination. In this case, the CPU of the report producing terminal 13, for example, carries out the inspection purpose determination process.

The operation tool for giving the command to change the display style is not also limited to the display style change button, but may be another kind operation tool.

The inspection purposes are sometimes expressed by variable terms from the radiological doctor to the radiological doctor. For example, some doctor uses ‘Screening’ in place of ‘Differential diagnosis between benign and malignant’. If the terms of the entered inspection purposes are not standardized, the retrieval is at high risk of causing such a trouble that expected findings cannot be extracted. Therefore, in a case where the inspection purpose is entered by the form of a text, a list of standardized terms for the inspection purposes should be displayed in the form of guidance, so that the texts of inspection purposes are written in the standardized terms.

In the above described embodiment, the linkage command is given through the manual entry on the report editor screen and the linkage between the finding and the inspection purpose is done according to the command. Instead of the manual entry of the linkage command, however, it is possible to execute a linkage process automatically. For example, on producing the report editor screen, the console controller automatically produces a plurality of entry areas corresponding to the respective inspection purposes specified in the order.

In other words, on producing the report editor screen, the inspection purposes contained in the order are assigned to the respective entry areas. And the entry areas display the individual purpose IDs (P-1 and P-2) of the assigned inspection purposes. The radiological doctors check the displayed purpose IDs and write the findings in the entry areas according to the inspection purpose. Then, the purpose ID of the entry area is added to data of the entered finding.

In the above described embodiment, the requesting doctor specifies the inspection purpose. Instead of the requesting doctor, however, the staff at the inspection department can specify the inspection purpose based on the content of the request from the requesting doctor.

In the above described embodiment, an observation record regarding a pathological lesion as noticed by the radiological doctor and a result of diagnosis, such as the name of disease diagnosed based on the observation record are not discriminated but put together into one finding. It is, however, possible to discriminate between the observation record and the result of diagnosis. In this case, for example, each entry field for entering a finding on a report editor screen is divided into a sub-entry field for the observation record and a sub-entry field for the result of diagnosis. Likewise, on the report display screen, the display field for the finding is divided into two sub-display fields for displaying the observation record and the result of diagnosis respectively. Even through the observation record and the result of diagnosis are discriminated like this, they constitute one finding as a unit. Therefore, the observation record and the result of diagnosis are not dealt with separately, and the data of both is used as the data of one finding in the process for the refined display or the sorted display.

In the above described embodiment, the text of the finding is entered by operating the keyboard, but it is possible to adopt a template entry style. For the template entry style, the report editor screen is provided with a template entry panel, which is an operation tool of selecting a pre-registered medical terms, to enter the finding text mainly by clicking operation of the mouse. The template entry panel consists of select buttons for selecting the pre-registered medical terms. As one of these select buttons is clicked on, the selected medical term is put in the entry area. In the above described embodiment, the keyboard and the mouse are used as the input device. It is, however, possible to use a microphone as an input device so that the findings and the operation commands may be received as voice signals.

Although the above embodiments have been described in conjunction with the inspection images gained from CT scans, the type of the inspection is of course not limited to the CT scans. The inspection images can be of other inspection types, including MRI scans, PET (Positron Emission Tomography) scans, ultrasonography and endoscopy. The reports have been explained as ones of radiological interpretation of the inspection images in the above described embodiments, but the reports can be ones that contain findings concerning other inspection data than the inspection images. As the inspection data other than the inspection images, there may be numerical data gained from a laboratory test such as a pathological test or one from a physiological test, or a waveform chart such as an electrocardiogram. It may be the report where the findings regarding various data including the inspection data of the different inspection types are noted down.

The present invention is not only applicable to reports about medical inspections, but to any medical reports containing remarks and findings relating to clinical examinations. Therefore, the purpose linked with the finding is not limited to the inspection purpose, but may be a purpose of request for the medical report, which the requesting doctor specifies in the order. Moreover, those who produce the medical reports are not limited to the radiological doctor. The present invention is applicable to any medical reports made by experts other than doctors, such as reports by physical therapists who instruct rehabilitations.

In the above described embodiment, the report system consists of a single report producing terminal and a single report server, but the report system can be constituted of a plurality of report producing terminals and report servers. It is also possible to unite the functions of the report producing terminal and the report server into one computer.

In this case, a program that unites the function of the client program installed in the report producing terminal and the function of the server program constitute the report program. The report system may include the report viewer terminals for reading the report. The report viewer terminals include the diagnosis-and-treatment department terminals as described in the above embodiment. In this case, the report program is configured to include the function of the client program for viewing the report.

A report viewer program for embodying the report viewer apparatus consists of a client program for viewing the report and the server program. To configure the report viewer apparatus in one computer, a program that units the function of the client program for viewing the report and the function of the server program constitutes the report viewer program.

When the information system is of a client-server type, which consists of clients, e.g. the diagnosis-and-treatment department terminals and the report producing terminal, and a server, e.g. the DB server, like the above described embodiment, it is possible to use a special program for the client to edit the report, as well as the above-described special program for the client to view the report. It is also possible to use a general-purpose browser compliant to WWW (World Wide Web) protocols such as HTTP (Hyper Text Transfer Protocol).

With the special program, the operation screen is produced based on screen data defined by the special program. With the general-purpose browser, the client accesses the Web server that stores, for example, the data of operation screens such as the report editor screen and the report display screen, to download data of the operation screen as converted into a Web page format. The browser of the client produces the operation screen, interpreting the source code of the received Web page. The DB server 14 may double as the Web server, or the Web server may be a different server from the DB server.

In the case where the Web server stores the data of the operation screens, a CPU of the Web server serves as the edit process device, the linking device, the order receiving device and the respective console controllers independently or in cooperation with the CPU 31 of the client.

The data storage device for building up the database is not limited to the above-described DB sever. For example, it is possible to use a storage device connected via a network such as NAS (Network Attached Storage) and SAN (Storage Area Network). As described above, the physical configuration of the computer system can be changed appropriately, and the present invention is not limited to the physical configuration according to the above described embodiments.

In the above described embodiment, LAN is used as the network. Where the diagnosis-and-treatment department and the inspection department are dispersed to many bases, however, it is possible to use a combination of LAN and WAN (Wide Area Network) as the network.

Moreover, the scope of the present invention is not limited to a system or an apparatus, but the present invention may be embodied as a program or a storage medium storing the program.

Thus, the present invention is not to be limited to the above embodiments but, on the contrary, various modifications will be possible without departing from the scope of claims appended hereto.

What is claimed is:

1. A medical report system comprising:
an editorial processing device for editing a medical report that contains a plurality of findings, among which at least one finding is entered in accordance with a designated purpose, in such a manner that data of each finding may be handled individually as a unit; and
a linking device for linking said at least one finding with said designated purpose.

2. A medical report system as recited in claim 1, further comprising an order taking device for taking an order that records contents of a request for producing said medical report, wherein at least a purpose is designated in said order and is read out from said order.

3. A medical report system as recited in claim 1, further comprising a first console control device for controlling a report editor screen as a graphical user interface, wherein said report editor screen is provided with a plurality of entry areas for entering a plurality of findings to be contained in said medical report.

4. A medical report system as recited in claim 3, wherein said report editor screen is provided with a first operation tool for designating a purpose to be linked with said finding entered in each of said entry areas, and said linking device links said finding with said purpose as designated by said first operation tool.

5. A medical report system as recited in claim 1, further comprising a second console control device for controlling a report display screen to display said medical report in such a manner that shows linkage between said findings and designated purposes.

6. A medical report system as recited in claim 5, wherein said report display screen is provided with a second operation tool, through which at least a purpose is designated to input a command to change display style of said findings corresponding to the designated purpose, and wherein said medical report system further comprises a device for executing a process of changing the display style of said findings on said report display screen in accordance with said command input through said second operation tool.

7. A medical report system as recited in claim 6, wherein the display style includes at least one of a refined display style and a sorted display style, wherein said refined display style is for displaying those findings on said report display screen which are retrieved using the designated purpose as a search key, whereas said sorted display style is for displaying said findings in groups sorted according to the designated purposes.

8. A medical report system as recited in claim 7, wherein a plurality of medical reports are included in the subject of said process of changing the display style.

9. A medical report system as recited in claim 8, wherein said plurality of medical reports include ones relating to different medical inspections and/or ones relating to past inspections.

10. A medical report system as recited in claim 6, wherein said second console control device controls an image display screen for displaying images relating to said medical report in cooperation with said report display screen, so as to switch the images or annotations inserted in the images on said image display screen in synchronism with the change in display style on said report display screen.

11. A medical report system as recited in claim 5, comprising a report producing apparatus provided with a first console control device for controlling a report editor screen as a graphical user interface, a report viewer apparatus provided with said second console control device, and a data storage in which a report database is built up for storing said medical reports, said data storage being connected to said report producing apparatus and said report viewer apparatus via a network so as to be able to communicate with each other.

12. A medical report viewer apparatus comprising:
a console control device for outputting a report display screen to a display device, said report display screen displaying a medical report containing a plurality of findings, among which at least one finding is entered in accordance with a designated purpose and is linked with said designated purpose, in such a manner that data of each finding may be handled individually as a unit, wherein said console control device controls said report display screen in response to an operation command entered through said report display screen by operating an input device; and
a device for executing a process of changing display style of said findings on said report display screen in accordance with a purpose or purposes designated through an operation tool provided on said report display screen.

13. A medical report program for programming a computer to perform functions of:
editing the medical report to contain a plurality of findings, among which at least one finding is entered in accordance with a designated purpose, in such a manner that data of each finding may be handled individually as a unit; and
linking said findings with respective purposes.

14. A method of editing and displaying a medical report, comprising steps of:
editing the medical report to contain a plurality of findings, among which at least one finding is entered in accordance with a designated purpose, in such a manner that data of each finding may be handled individually as a unit;
linking said findings with respective purposes; and
outputting a report display screen that displays said findings as contained in said medical report in such a manner that said findings are distinguishable from each other.
